(19) United States
(12) Patent Application Publication
(10) Pub. No.: US 2015/0143805 A1
(43) Pub. Date: May 28, 2015

(54) POWER GENERATION/TRANSMISSION DEVICE

(71) Applicant: Kazue YAMAMOTO, (US)

(72) Inventor: Norio Azegami, Niigata (JP)

(21) Appl. No.: 14/406,357

(22) PCT Filed: Jun. 7, 2013
(86) PCT No.: PCT/JP2013/065784

§ 371 Date: Dec. 8, 2014

(30) Foreign Application Priority Data
Jun. 8, 2012 (JP) 2012-131287
Sep. 28, 2012 (JP) 2012-216643

(51) Int. Cl. F03B 17/02; F03B 17/04; F16H 23/08

(52) U.S. Cl. CPC F03B 17/025; F16H 23/08; F03B 17/04
USPC 60/495

(57) ABSTRACT

Provided is a power generation/transmission device capable of obtaining stable power by utilizing rising and falling motion of rods and rolling motion of a spherical body. The power generation/transmission device includes: drive rods F1 to F3 capable of rising and falling in a vertical direction; a drive rotating disc 3 supported to be three-dimensionally rotatable about a first universal joint 41 to rotate on a conical trajectory along a circular track of a first angle restricting plate 43 disposed below the drive rotating disc 3; and a first spherical body 32 placed on the drive rotating disc 3 to be capable of rolling motion. The drive rotating disc 3 is rotated by the rising and falling motion of the drive rods F1 to F3 and the rolling motion of the first spherical body 32.

### TECHNICAL FIELD

The present invention relates to a power generation/transmission device for generating and transmitting power by utilizing rising and falling motion of rods and rolling motion of a spherical body.

### BACKGROUND ART

As conventional electric power generation methods, thermal electric power generation in which reaction heat energy of fuel such as petroleum and natural gas is converted into electric power, and nuclear electric power generation utilizing nuclear power are known. In the thermal electric power generation and the nuclear electric power generation, heat energy is generated artificially or chemically and the heat energy is converted into electric energy. In recent years, many problems such as influence of earthquake disaster and depletion of fuel are coming to the surface.

Instead of utilizing the nuclear power and the thermal power, research and development of electric power generation utilizing natural energy such as wind power and sunlight are advancing (e.g., refer to Patent Literature 1). However, utilization of the natural energy has difficulty in obtaining stable and inexpensive electric energy.

### CITATION LIST

### Patent Literature

### Patent Literature 1: JP 2011-117363 A

### SUMMARY OF INVENTION

### Technical Problem

In order to stably obtain electric energy from a “movement” in a natural phenomenon, the “movement” in the natural phenomenon itself needs to be stable and continuous and the “movement” in the natural phenomenon needs to be controllable. If electric energy can be obtained by utilizing rising/falling motion of rods and rolling motion of a spherical body, which are stable and continuous “movements”, it is possible to obtain stable electric energy.

Therefore, it is an object of the present invention to provide a power generation/transmission device with which it is possible to obtain stable power by utilizing rising/falling motion of rods and rolling motion of a spherical body.

### Solution to Problem

To achieve the above object, according to an aspect of the present invention, there is provided a power generation/transmission device including: a plurality of drive rods capable of rising and falling in a vertical direction; a drive rotating disc supported to be three-dimensionally rotatable about a first universal joint to rotate on a conical trajectory along a circular track of a first angle restricting plate disposed below the drive rotating disc; and a first spherical body placed on the drive rotating disc to be capable of rolling motion on a periphery of the drive rotating plate, wherein the drive rotating disc is placed on upper ends of the plurality of drive rods to be slidable in a circumferential direction, and rising and falling motion of the plurality of drive rods and the rolling motion of the first spherical body are used to rotate the drive rotating disc.

### Advantageous Effects of Invention

According to the aspect of the invention, it is possible to rotate the drive rotating disc by utilizing the rising and falling motion of the drive rods and the rolling motion of the first spherical body. By taking out power from the drive rotating disc, it is possible to obtain the stable power which is a combination of the rising and falling motion of the drive rods and the rolling motion of the first spherical body.

### BRIEF DESCRIPTION OF DRAWINGS

FIG. 1 illustrates a schematic diagram (side view) of a power generation/transmission device according to a first embodiment of the present invention.

FIG. 2 illustrates a detailed view of the lower part of the power generation/transmission device according to the embodiment.

FIG. 3 illustrates a detailed view of the upper part of the power generation/transmission device according to the embodiment.

FIG. 4 illustrates a diagrammatic sketch of rotation of a special rotating disc on a conical trajectory.

FIG. 5 illustrates a diagram (the upper part illustrates a plan view and the lower part illustrates a side view) showing positional relationships of drive rods and control rods with a drive rotating disc.

FIG. 6 illustrates a perspective view showing movements of the control rod.

FIG. 7 illustrates a schematic diagram of a power generation/transmission device according to a second embodiment of the invention.

FIG. 8 illustrates a diagrammatic sketch showing a fanning phenomenon.

FIG. 9 illustrates a detailed view of a drive rotating disc of the power generation/transmission device according to the second embodiment of the invention.

FIG. 10 illustrates an enlarged view of the drive rotating disc.

FIG. 11 illustrates a detailed view of a special rotating disc of the power generation/transmission device according to the second embodiment of the invention.

FIG. 12 illustrates a schematic diagram of a power generation/transmission device according to a reference example similar to the invention.

FIG. 13 illustrates a schematic diagram (side view) of a drive mechanism of the power generation/transmission device according to the reference example.

### DESCRIPTION OF EMBODIMENTS

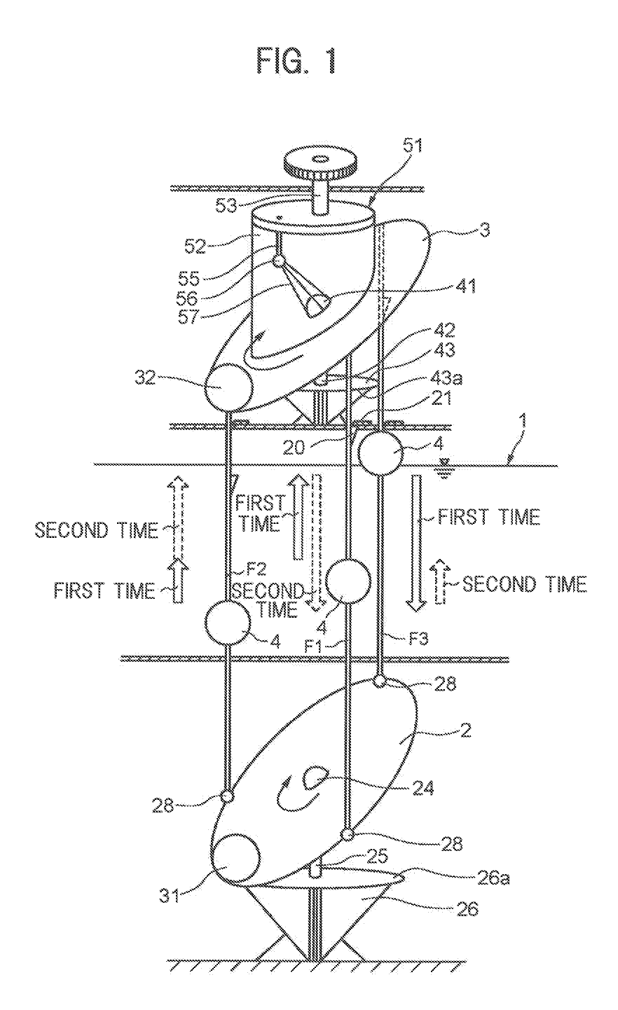

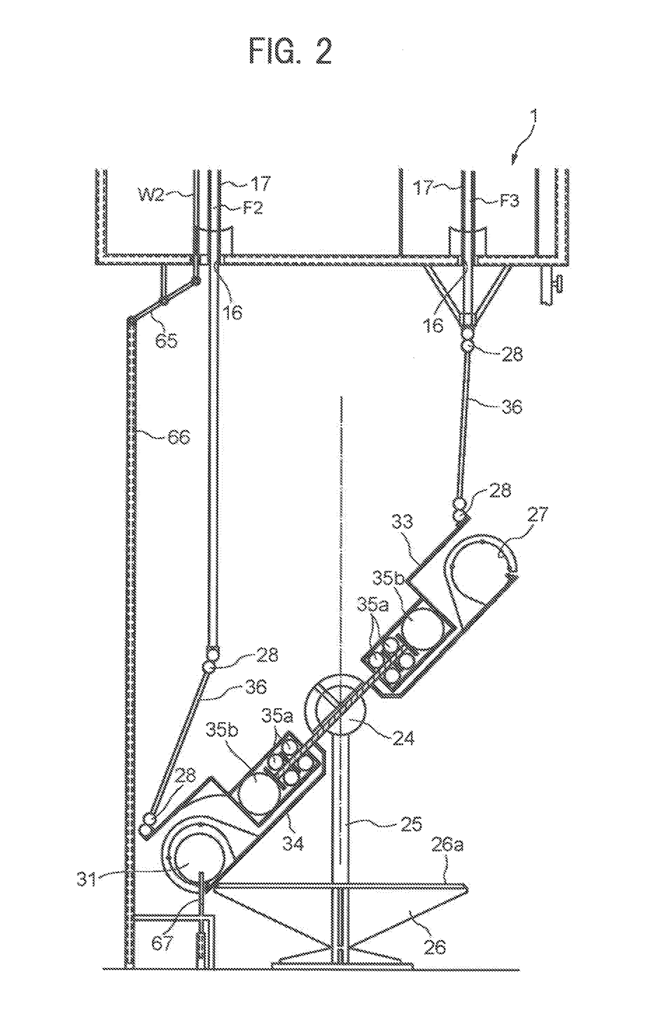

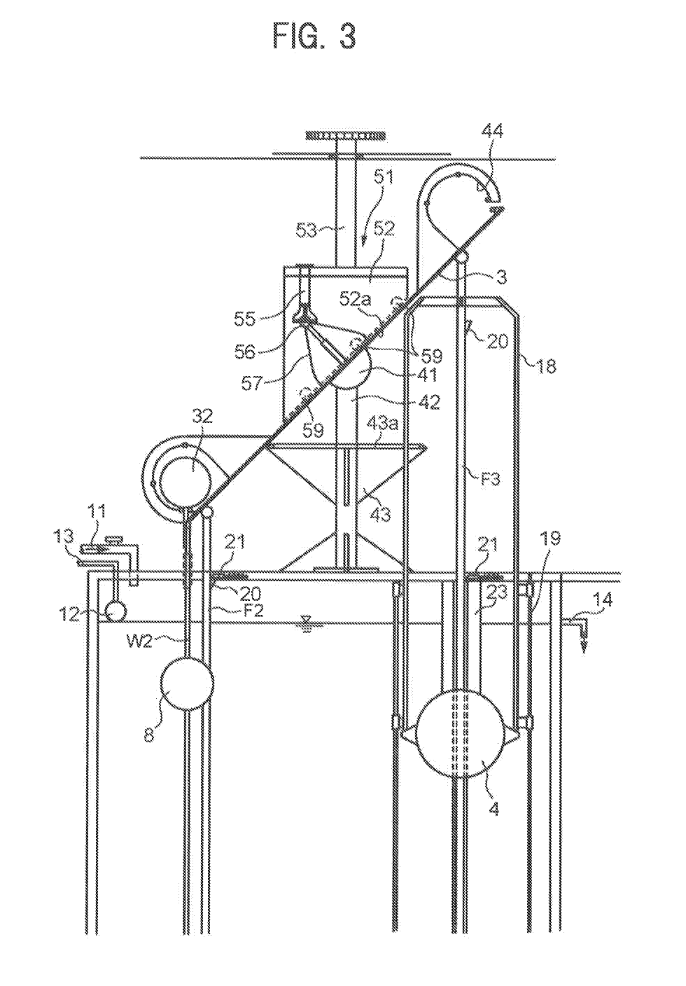

A power generation/transmission device according to an embodiment of the present invention will be described below in detail with reference to the drawings. FIG. 1 illustrates a schematic diagram of the power generation/transmission device according to the first embodiment of the invention. FIG. 2 illustrates a detailed view of the lower part of the power generation/transmission device. FIG. 3 illustrates a detailed view of the upper part of the power generation/transmission device. First, a structure of the power generation/transmission device according to the first embodiment of the invention will be described.

As illustrated in FIG. 1, the power generation/transmission device according to the embodiment includes a water tank 1 as a storage tank for storing liquid, a special rotating disc 2 disposed below the water tank 1, and a drive rotating disc 3 disposed above the water tank 1 as basic components. For example, the water tank 1 is disposed on a second floor of a building, the special rotating disc 2 is disposed on a first floor of the building, and the drive rotating disc 3 is disposed on a third floor of the building.

In the water tank 1, water is stored as liquid. As illustrated in the detailed view in FIG. 3, the water tank 1 is provided with a pipe 11 for feeding the water, a float sensor 12 for maintaining a constant level of a water surface in the water tank 1, a supply pipe 13 for a water supplement, and an overflow pipe 14 for discharging overflow water. When the water in the water tank 1 evaporates, the water is automatically supplied into the water tank 1 so as to maintain the constant level of the water surface. Rainwater can be used as the water to be supplied.

As illustrated in FIG. 1, three drive rods F1 to F3, for example, are provided to be able to rise and fall in a vertical direction in the water tank 1. Each of the drive rods F1 to F3 is provided with a float 4 for receiving buoyancy from the water. The drive rods F1 to F3 pass through the water tank 1. Lower ends of the drive rods F1 to F3 are connected to the special rotating disc 2. On upper ends of the drive rods F1 to F3, the drive rotating disc 3 is placed. The special rotating disc 2 performs a function of lifting and lowering the plurality of drive rods F1 to F3. The drive rods F1 to F3 connect the special rotating disc 2 to the drive rotating disc 3 so as to synchronize rotary motion of the special rotating disc 2 on a conical trajectory with rotary motion of the drive rotating disc 3 on a conical trajectory.

As illustrated in the detailed view in FIG. 2, through holes 16 through which the drive rods F1 to F3 rise and fall are formed in a bottom portion of the water tank 1. A waterproof pipe 17 for preventing leakage of water from the water tank 1 is mounted on each of the through holes 16. The drive rods F1 to F3 rise and fall through the waterproof pipes 17. As illustrated in the detailed view in FIG. 3, a cylindrical auxiliary rod 18 is coupled to a periphery of an upper portion of each of the drive rods F1 to F3. A rod guide 19 is mounted inside the water tank 1 to guide rising and falling movements of the auxiliary rod 18. Each of the drive rods F1 to F3 is coupled to the auxiliary rod 18 and the rising and falling movements of each of the drive rods F1 to F3 are guided by the rod guide 19.

A rod stopper 20 for controlling the rising and falling movements of each of the drive rods F1 to F3 is attached to each of the drive rods F1 to F3. A stopper engagement device 21 to be engaged with each of the rod stoppers 20 is provided to the water tank 1. When the rod stopper 20 is engaged with the stopper engagement device 21, an upward movement of each of the drive rods F1 to F3 is restricted (refer to FIG. 1). On the other hand, when the rod stopper 20 and the stopper engagement device 21 are disengaged from each other, each of the drive rods F1 to F3 rises the buoyancy of the float. In an upper portion of the water tank 1, a float stopper 23 for coming in contact with each of the floats 4 to restrict an upward movement of the float 4 is provided. The float stopper 23 defines a position of an uppermost end of each of the drive rods F1 to F3.

As illustrated in FIG. 1, the special rotating disc 2 is disposed below the water tank 1. The special rotating disc 2 is supported by a second universal joint 24 such as a spherical bearing to be able to rotate three-dimensionally. The second universal joint 24 is coupled to an upper end of a support column 25. A second angle restricting plate 26 is disposed below the special rotating disc 2. A circular track 26a is formed at an upper portion of the second angle restricting plate 26. The special rotating disc 2 rotates on the conical trajectory along the circular track.

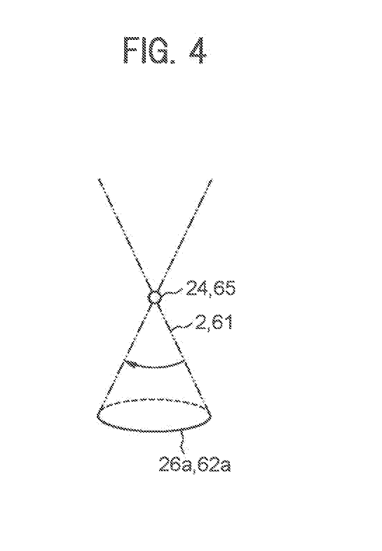

FIG. 4 shows the trajectory of the special rotating disc 2 rotating along the circular track. In FIG. 4, a line connecting a contact position between the special rotating disc 2 and the circular track 26a of the second angle restricting plate 26 to the universal joint is illustrated in a two-dot chain line. The special rotating disc 2 rotates on the conical trajectory about the second universal joint 24.

As illustrated in FIG. 1, a second spherical body 31 is placed to be capable of rolling motion on the special rotating disc 2. On the special rotating disc 2, a circular passage 27 for guiding the second spherical body 31 is formed about the second universal joint 24 (refer to FIG. 2). The second spherical body 31 performs rolling motion on the periphery of the special rotating disc 2 along the circular passage 27. This passage 27 serves as a track for the second spherical body 31 rolling on the special rotating disc 2. When the special rotating disc 2 tilts from a horizontal level, the second spherical body 31 starts to perform the rolling motion on the special rotating disc 2. Because the second spherical body 31 has mass, it moves to a lowermost position on the special rotating disc 2.

To the special rotating disc 2, the plurality of drive rods F1 to F3 are connected at equal intervals in a circumferential direction with universal joints 28 such as spherical bearings interposed therebetween. In the present embodiment, the three drive rods F1 to F3 are connected at intervals of 120 degrees in the circumferential direction.

As illustrated in the detailed view in FIG. 2, the special rotating disc 2 includes a rod connecting disc 33 to which the three drive rods F1 to F3 are connected and a spherical body placing disc 34 on which the second spherical body 31 is placed. A large number of spherical bodies 35a and 35b are disposed between the rod connecting disc 33 and the spherical body placing disc 34 so that the spherical body placing disc 34 can rotate about the second universal joint 24 relative to the rod connecting disc 33. Because the three drive rods F1 to F3 are connected to the rod connecting disc 33, rotation of the rod connecting disc 33 is restricted. Therefore, when the special rotating disc 2 rotates on the conical trajectory along the circular track, the spherical body placing disc 34 rotates on a conical trajectory along the circular track while the rod connecting disc 33 only swings. In order to allow the rod connecting disc 33 to swing, each of the drive rods F1 to F3 is connected to the rod connecting disc 33 with a joint rod 36 interposed therebetween. Each of the joint rods 36 is connected to each of the drive rods F1 to F3 and the rod connecting disc 33 with the universal joints 28 such as spherical bearings interposed therebetween.

As illustrated in FIG. 1, the drive rotating disc 3 is disposed above the water tank 1. The drive rotating disc 3 is supported to be able to rotate three-dimensionally by a first universal joint 41 such as a spherical joint. The first universal joint 41 is coupled to an upper end of a support column 42. A first angle restricting plate 43 is disposed below the drive rotating disc 3. A circular track 43a is formed at an upper portion of the first angle restricting plate 43. The drive rotating disc 3 rotates on the conical trajectory along the circular track about the first universal joint 41 similarly to the special rotating disc 2.

A first spherical body 32 is placed to be capable of rolling motion on the drive rotating disc 3. On the drive rotating disc 3, a circular passage 44 for guiding the first spherical body 32 is formed about the first universal joint 41 (refer to FIG. 3). The first spherical body 32 performs the rolling motion on the periphery of the drive rotating disc 3 along the circular passage 44. This passage 44 serves as a track for the first spherical body 32 rolling on the drive rotating disc 3. When the drive rotating disc 3 tilts from a horizontal level, the first spherical body 32 starts to perform the rolling motion on the drive rotating disc 3. Because the first spherical body 32 has mass, it moves to a lowermost position on the drive rotating disc 3.

The drive rotating disc 3 is slidably placed on the upper ends of the three drive rods F1 to F3. Because the special rotating disc 2 is connected to the lower ends of the three drive rods F1 to F3, the drive rotating disc 3 moves while synchronized with the special rotating disc 2. Because the drive rotating disc 3 is slidably placed on the three drive rods F1 to F3, the drive rotating disc 3 is allowed to rotate on the conical trajectory along the circular track by the movement synchronized with the special rotating disc 2.

On the drive rotating disc 3, a motion converting mechanism 51 for converting the rotary motion of the drive rotating disc 3 into rotary motion about a center line of an output shaft 53 is provided. As illustrated in the detailed view in FIG. 3, the motion converting mechanism 51 includes a circular columnar main body portion 52 and the output shaft 53 connected to the main body portion 52. A bottom face of the circular columnar main body portion 52 is a slope 52a. A plurality of spherical bodies 59 are embedded into the slope 52a to come in contact with the tilting drive rotating disc 3. The main body portion 52 is hollow. A support shaft 55 hangs from a position of a ceiling face of the main body portion 52 and displaced in a horizontal direction from the output shaft 53. At a tip end of the support shaft 55, a connecting portion 57 connected to the first universal joint 41 with a universal joint 56 such as a spherical bearing interposed therebetween is provided. When the drive rotating disc 3 rotates on a conical trajectory about the first universal joint 41, the output shaft 53 rotates about the center line. From this output shaft 53, a force which is the resultant of a rotating force of the drive rotating disc 3 and a centrifugal force of the first spherical body 32 is output.

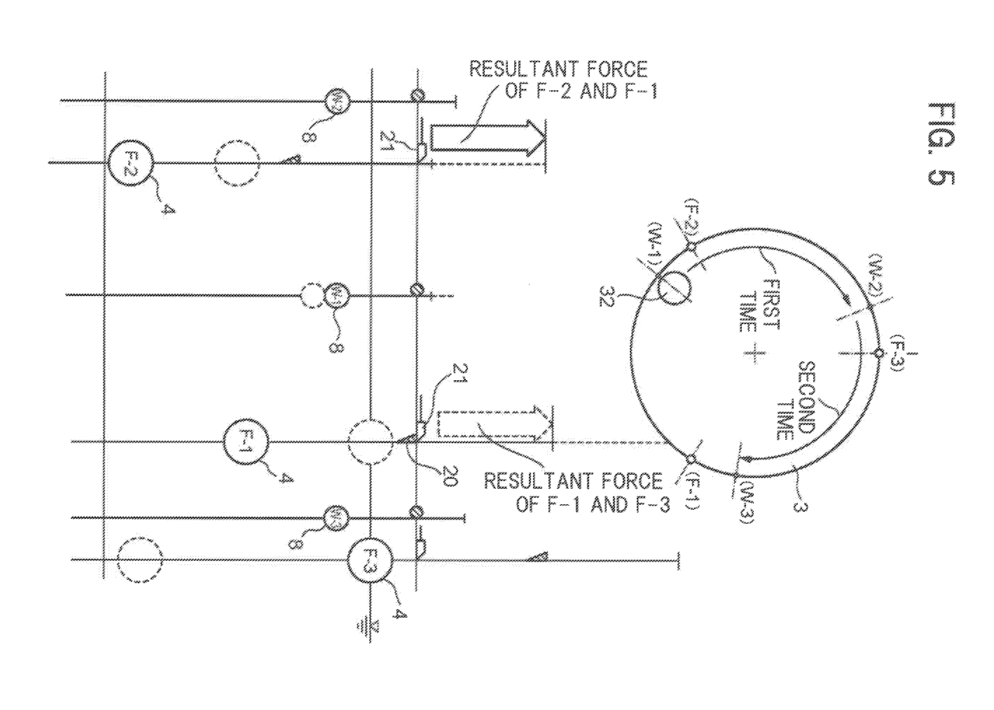

FIG. 5 shows positions of the drive rods F1 to F3 and the control rods W1 to W3 with respect to the drive rotating disc 3. Besides the drive rods F1 to F3, the three control rods W1 to W3 the number of which is equal to that of the drive rods F1 to F3 are connected to the drive rotating disc 3. The three control rods W1 to W3 are disposed at equal intervals (intervals of 120 degrees in the embodiment) in a circumferential direction at the drive rotating disc 3. The control rods W1 to W3 are for controlling the drive rods F1 to F3, the control rod W1 controls the drive rod F1, the control rod W2 controls the drive rod F2, and the control rod W3 controls the drive rod F3. The control rods W1 to W3 can rise and fall relative to the water tank 1. A control float 8 disposed in the water tank 1 is provided to each of the control rods W1 to W3.

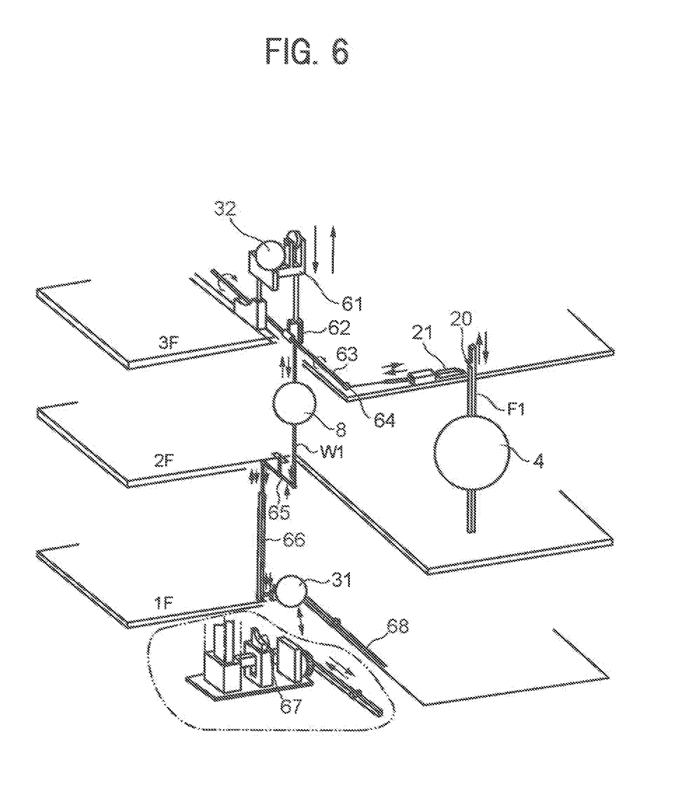

FIG. 6 illustrates a detailed view of the control rod W1 and the drive rod F1. As illustrated in FIG. 6, when the first spherical body 32 performs the rolling motion to the position of W1 on the drive rotating disc 3, the first spherical body 32 mounts a weight stopper 61 and the weight stopper 61 falls due to the mass of the first spherical body 32. When the weight stopper 61 falls, a level gear 62 rotates a control rotating shaft 63. The control rotating shaft 63 is connected to the stopper engagement device 21 with a bevel gear 64 or the like interposed therebetween. When the control rotating shaft 63 rotates, the stopper engagement device 21 recedes from the rod stopper 20, and the stopper engagement device 21 and the rod stopper 20 get disengaged from each other.

When the first spherical body 32 performs the rolling motion to the position of W1 on the drive rotating disc 3 and the weight stopper 61 falls, a control rod guide 66 connected to the control rod W1 with a seesaw portion 65 (refer to FIG. 2) interposed therebetween rises. When the control rod guide 66 rises, a weight stopper 67 (refer to FIG. 2) provided to the special rotating disc 2 falls and the lock on the second spherical body 31 by the weight stopper 67 gets released. A link shaft 68 is provided to link a plurality of power generation/transmission devices together.

In this manner, when the first spherical body 32 mounts the weight stopper 61 of the drive rotating disc 3, the stopper engagement device 21 recedes from the rod stopper 20 of the drive rod F1 and the lock gets released. The weight stopper 67 of the special rotating disc 2 releases the lock on the second spherical body 31.

The structure of the power generation/transmission device according to the embodiment has been described above. A principle of actuation of the power generation/transmission device according to the embodiment will be described below with reference to FIGS. 1 to 5.

As illustrated in FIG. 5, when the first spherical body 32 reaches the position of W1 on the drive rotating disc 3, the stopper engagement device 21 releases the lock on the drive rod F1 and the weight stopper 67 (W1) of the special rotating disc 2 releases the lock on the second spherical body 31 (refer to FIG. 2) as described above. Thereupon, as illustrated in FIG. 1, the drive rod F1 rises due to the buoyancy. The special rotating disc 2 tilts due to leverage as a result of the rising of the drive rod F1 and the second spherical body 31 performs the rolling motion on the special rotating disc 2. Thereafter, the first and second spherical bodies 32 and 31 move from the position of W1 to the position of W2 in FIG. 5 on the special rotating disc 2 and the drive rotating disc 3 (the first time). Because the gravity of the first spherical body 32 and the gravity of the second spherical body 31 decrease as a result of the rolling motion of the first spherical body 32 and the second spherical body 31, the drive rod F2 rises due to the buoyancy of the float 4 until it comes in contact with the stopper engagement device 21. The buoyancy of the drive rod F1 and the buoyancy of the drive rod F2 form a resultant force and the resultant force draws the float 4 of the drive rod F3 deep into the water. In FIG. 1, the rising and falling movements of the drive rods F1, F2, and F3 when the first and second spherical bodies 32 and 31 move from W1 to W2 are illustrated as the first time. As the drive rods F1, F2, and F3 rise and fall, the special rotating disc 2 and the drive rotating disc 3 rotate clockwise.

Next, when the second spherical body 31 moves from W2 to W3 in FIG. 5, the similar movements are repeated. When the second spherical body 31 reaches the position of W2 on the drive rotating disc 3, the stopper engagement device 21 releases the lock on the drive rod F2 and the weight stopper 67 (W2) of the special rotating disc 2 releases the lock on the first spherical body 32 as described above. Thereupon, as illustrated in FIG. 1, the drive rod F2 rises due to the buoyancy. The special rotating disc 2 tilts due to leverage as a result of the rising of the drive rod F2 and the first spherical body 32 performs the rolling motion on the special rotating disc 2. Thereafter, the first and second spherical bodies 32 and 31 move from the position of W2 to the position of W3 in FIG. 5 on the special rotating disc 2 and the drive rotating disc 3 (the second time). Because the gravity of the first spherical body 32 and the gravity of the second spherical body 31 decrease as a result of the rolling motion of the first spherical body 32 and the second spherical body 31, the drive rod F3 rises due to the buoyancy of the float 4 until the rod stopper 20 of the drive rod F3 comes in contact with the stopper engagement device 21. A resultant force of the buoyancy of the drive rod F2 and the buoyancy of the drive rod F3 draws the float of the drive rod F1 deep into the water. In FIG. 1, the rising and falling movements of the drive rods F1, F2, and F3 when the first and second spherical bodies 32 and 31 move from W2 to W3 are illustrated as the second time.

Because the similar movement is repeated when the second spherical body 31 moves from W3 to W1 in FIG. 5, detailed description will be omitted. One cycle is finished in the above-described manner. By repeating the one cycle, it is possible to keep the rotation of the special rotating disc 2 and the drive rotating disc 3. By taking out the power from the rotation of the drive rotating disc 3, it is possible to obtain the stable power.

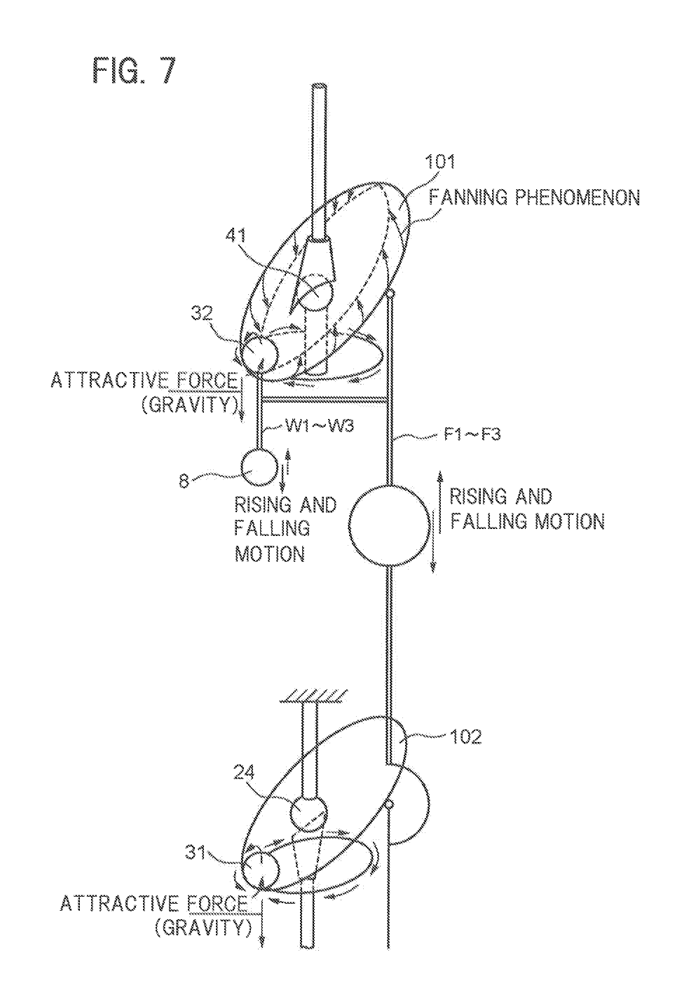

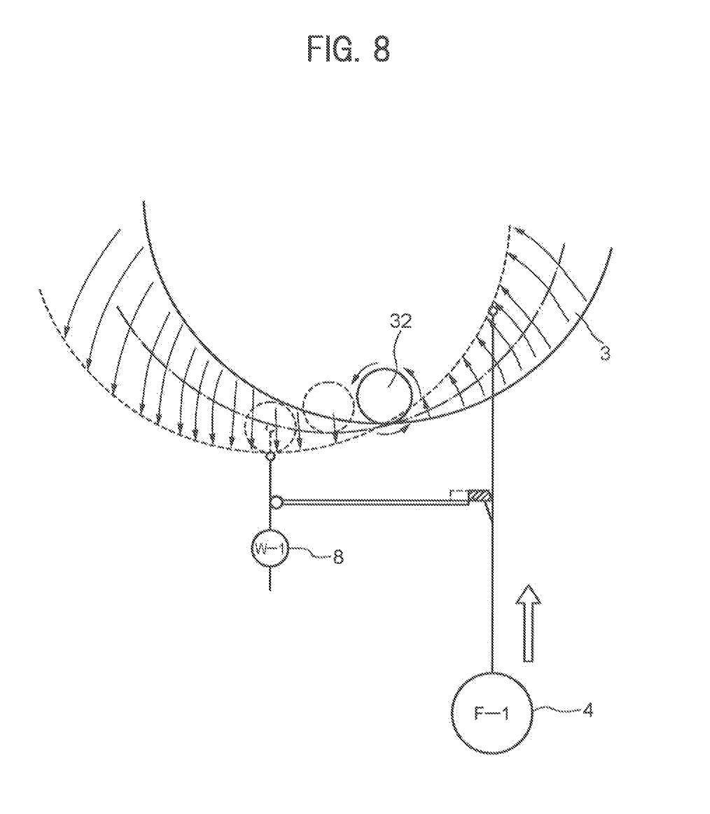

In the power generation/transmission device according to the embodiment, the buoyancy of the floats 4 and the gravity of the first and second spherical bodies 32 and 31 are used as drive sources to lift and lower the drive rods F1, F2, and F3. When the drive rods F1, F2, and F3 rise and fall as described above, the drive rotating disc 3 placed on the upper ends of the drive rods F1, F2, and F3 rotates on the conical trajectory. At this time, the drive rotating disc 3 rotates while tilted by the drive rods F1, F2, and F3. The rotation of the drive rotating disc 3 in the tilting state is referred to as a fanning phenomenon (refer to FIGS. 7 and 8). FIG. 8 illustrates a diagrammatic sketch of the fanning phenomenon. When the drive rotating disc 3 rotates on the conical trajectory, the buoyancy of the floats 4 tilt the drive rotating disc 3. The tilt is illustrated by an arrow. The tilt of the drive rotating disc 3 accelerates rotation of the first spherical body 32. Therefore, the fanning phenomenon of the drive rotating disc 3 causes the first spherical body 32 to rotate and revolve swiftly. Similarly, a fanning phenomenon of the special rotating disc 2 occurs as well to cause the second spherical body 31 to rotate and revolve swiftly. If a generator is connected to the output shaft 53, it is possible to take out the motion energy of the rotation of the drive rotating disc 3 and the special rotating disc 2 on the conical trajectories and the motion energy of the rotation and the revolution of the first and second spherical bodies 32 and 31 as electric energy. Water is fed to the water tank 1 to make up evaporated water to thereby allow the power generation/transmission device in the embodiment to obtain energy from the outside.

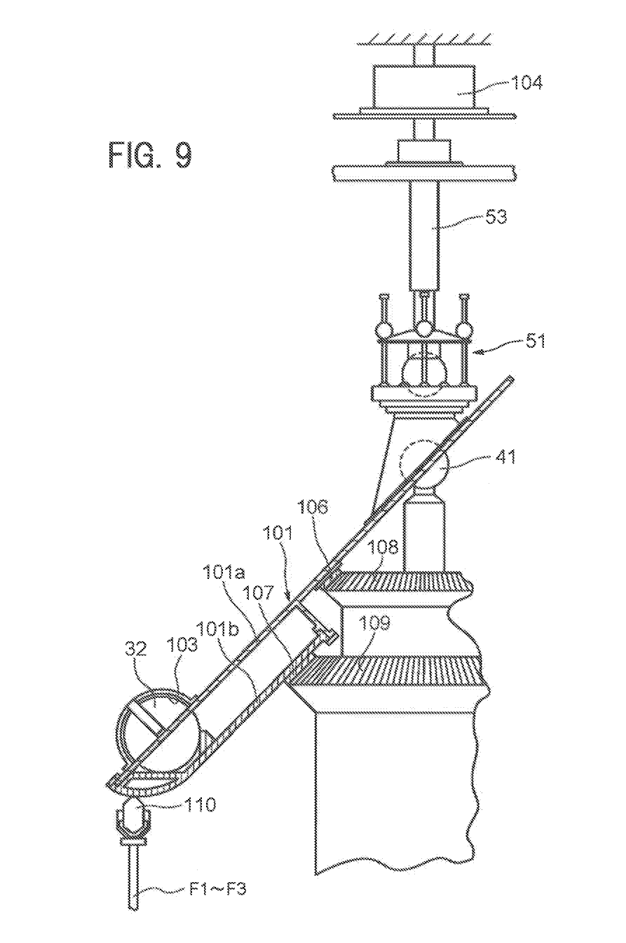

FIG. 9 illustrates a schematic diagram of a power generation/transmission device according to a second embodiment of the invention. The power generation/transmission device according to the embodiment similarly includes a drive rotating disc 101, a special rotating disc 102, drive rods F1 to F3 for synchronizing rotation of the drive rotating disc 101 with rotation of the special rotating disc 102, and control rods W1 to W3 for controlling the drive rods F1 to F3. Because the drive rods F1 to F3, the control rods W1 to W3, and floats 4 have the same structures as those of the power generation/transmission device in the first embodiment, they will be provided with the same reference signs and will not be described.

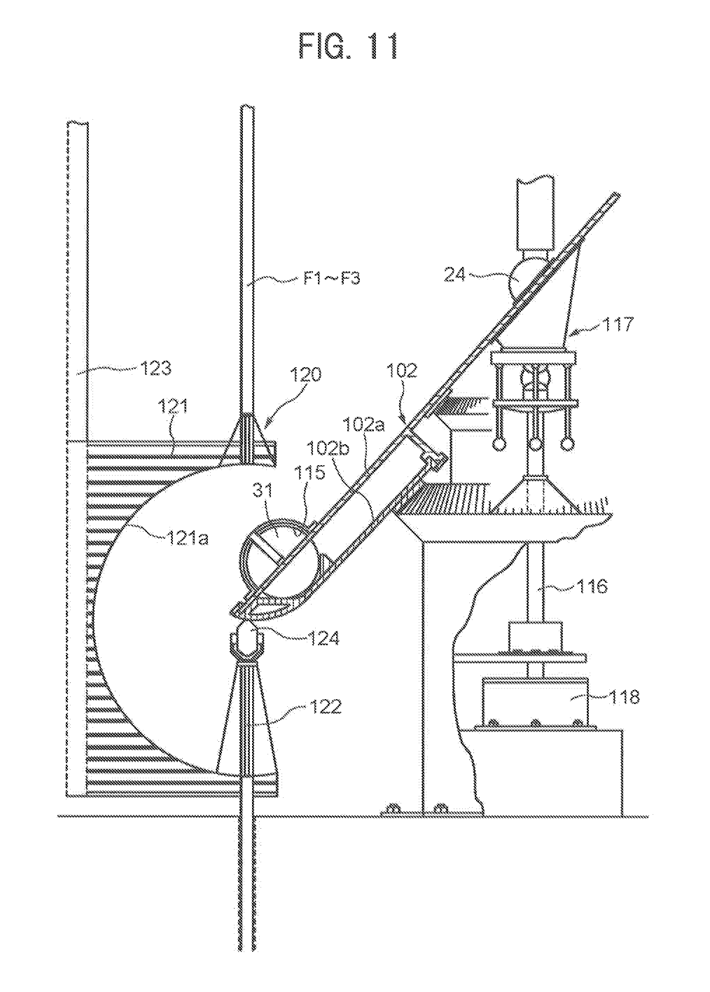

In the power generation/transmission device in the second embodiment, the drive rotating disc 101 is formed by two discs, i.e., a spherical body rolling disc 101b and a spherical body housing disc 101a (refer to FIG. 9). The special rotating disc 102 is formed by two discs, i.e., a spherical body rolling disc 102b and a spherical body housing disc 102a similarly to the drive rotating disc 101 (refer to FIG. 11).

FIG. 9 illustrates a detailed view of the drive rotating disc 101. In FIG. 9, only a left half of the drive rotating disc 101 is illustrated and a right half thereof is omitted. The drive rotating disc 101 includes the doughnut-shaped spherical body rolling disc 101b on which a first spherical body 32 is placed for rolling motion and the spherical body housing disc 101a for rotating about a first universal joint 41 relative to the spherical body rolling disc 101b. The spherical body rolling disc 101b and the spherical body housing disc 101a are parallel to each other. A housing portion 103 for housing the first spherical body 32 is formed in the spherical body housing disc 101a. The first spherical body 32 rolls on the spherical body rolling disc 101b to thereby cause the spherical body housing disc 101a to rotate relative to the spherical body rolling disc 101b. A motion converting mechanism 51 converts the rotation of the spherical body housing disc 101a into rotation of an output shaft 53. Energy of the rotation of the output shaft 53 is taken out as electric energy by a generator 104. Because the spherical body housing disc 101a rotates at a higher speed than the spherical body rolling disc 101b, it is possible to take out larger output.

As illustrated in FIG. 9, pinions 106 and 107 are rotatably mounted on the spherical body rolling disc 101b and the spherical body housing disc 101a, respectively. A first angle restricting plate 43 is provided with ring-shaped gears 108 and 109 to be engaged with the pinions 106 and 107. The pinion 106 keeps performing the same motion at the same speed as the spherical body rolling disc 101b and the pinion 107 keeps performing the same motion at the same speed as the spherical body housing disc 101a. The pinions 106 and 107 and the gears 108 and 109 stabilize the rotary motion of the spherical body rolling disc 101b and the spherical body housing disc 101a on conical trajectories. Because a fanning phenomenon becomes less likely to occur when the spherical body rolling disc 101b is synchronized in a rotation direction with the high-speed rotation of the spherical body housing disc 101a, the pinion 107 exerts an effect of preventing synchronized rotation. At an upper end of each of the drive rods F1 to F3, a roller 110 for coming in contact with the spherical body rolling disc 101b is provided so as to reduce friction between each of the drive rods F1 to F3 and the spherical body rolling disc 101b.

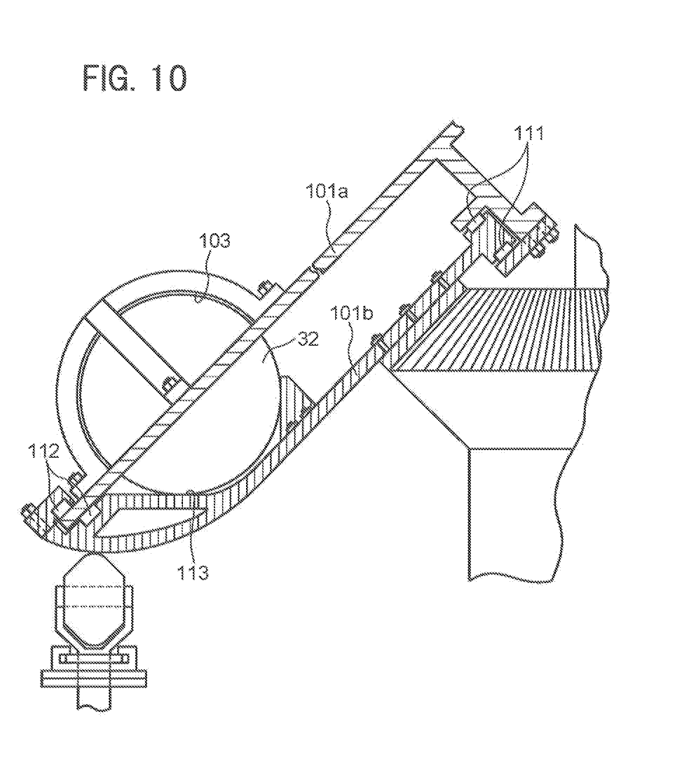

FIG. 10 illustrates a detailed view of the spherical body rolling disc 101b and the spherical body housing disc 101a. Between the spherical body rolling disc 101b and the spherical body housing disc 101a, rolling bodies 111 and 112 are disposed to be capable of rolling motion so that the spherical body housing disc 101a can rotate relative to the spherical body rolling disc 101b. A rolling surface 113 of the spherical body rolling disc 101b in contact with the first spherical body 32 is formed as a horizontal surface. This is for allowing the first spherical body 32 to roll with the minimum frictional resistance when the spherical body rolling disc 101b tilts.

FIG. 11 illustrates a detailed view of the special rotating disc 102. The special rotating disc 102 includes a doughnut-shaped spherical body rolling disc 102b on which a second spherical body 31 is placed to be capable of rolling motion and a spherical body housing disc 102a to be rotatable about a second universal joint 24 relative to the spherical body rolling disc 102b. The spherical body rolling disc 102b and the spherical body housing disc 102a are parallel to each other. A housing portion 115 for housing the second spherical body 31 is formed in the spherical body housing disc 102a. The second spherical body 31 rolls on the spherical body rolling disc 102b to thereby cause the spherical body housing disc 102a to rotate relative to the spherical body rolling disc 102b. Because the spherical body rolling disc 102b and the spherical body housing disc 102a have substantially the same structures as the spherical body rolling disc 101b and the spherical body housing disc 101a of the drive rotating disc 101, they will not be described in detail. In the embodiment, a motion converting mechanism 117 for converting the rotation of the spherical body housing disc 102a of the special rotating disc 102 into rotation of an output shaft 116 and a generator 118 for taking out electric energy from the output shaft 116 are further provided.

At a lower end of each of the drive rods F1 to F3, a pinching portion 120 for pinching the special rotating disc 102 in a vertical direction is provided. The pinching portion 120 includes a main body portion 121 coupled to the lower end of each of the drive rods F1 to F3 and a lower rod 122 for supporting the special rotating disc 102 from below. The fanning phenomenon of the special rotating disc 102 occurs as well in the above-described manner. In order to avoid interference between the special rotating disc 102 exhibiting the fanning phenomenon and the main body portion 121, a U-shaped clearance groove 121a is formed in the main body portion 121. Rising and falling motion of the main body portion 121 is guided by a guide 123. On an upper end of the lower rod 122, the special rotating disc 102 is placed for sliding. In order to reduce frictional resistance between the lower rod 122 and the special rotating disc 102, a roller 124 is provided to the upper end of the lower rod 122.

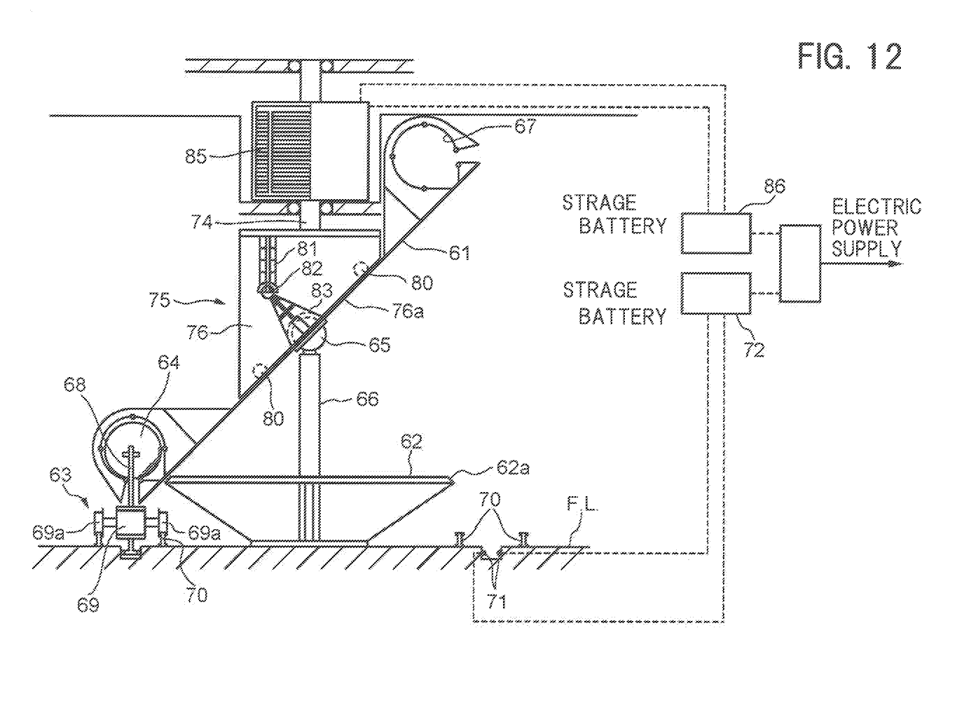

FIG. 12 illustrates a schematic diagram of a power generation/transmission device according to a reference example similar to the invention. Although as large output as that of the invention cannot be obtained because rising and falling motion of rods is not utilized, the reference example is similar to the invention in that it includes a drive rotating disc 61, an angle restricting plate 62, a spherical body 64, and a drive mechanism 63 as basic components.

The drive rotating disc 61 is supported by a universal joint 65 such as a spherical bearing to be able to rotate three-dimensionally. A support column 66 stands on a floor face F.L. and the universal joint 65 is coupled to an upper end of the support column 66. Below the drive rotating disc 61, the angle restricting plate 62 is disposed. A circular track 62a for coming in contact with a back face of the drive rotating disc 61 is formed at an outer periphery of the angle restricting plate 62. The drive rotating disc 61 rotates on a conical trajectory along the circular track 62a of the angle restricting plate 62.

The conical trajectory of the drive rotating disc 61 is the same as that illustrated in FIG. 4. In FIG. 4, a line connecting a contact position between the drive rotating disc 61 and the circular track 62a of the angle restricting plate 62 to the universal joint 65 is illustrated in a two-dot chain line. The drive rotating disc 61 rotates on the conical trajectory about the universal joint 65.

As illustrated in FIG. 12, on the drive rotating disc 61, the spherical body 64 is placed to be capable of rolling motion. On the drive rotating disc 61, a circular passage 67 for guiding the spherical body 64 is formed about the universal joint 65. This passage 67 serves as a track for the spherical body 64 rolling on the drive rotating disc 61.

The spherical body 64 is caused to perform the rolling motion on the drive rotating disc 61 by the drive mechanism 63. The drive mechanism 63 includes a pushing member 68 for pushing the spherical body 64, a carriage 69 to which the pushing member 68 is fixed, and a circular rail 70 on which the carriage 69 moves. In the carriage 69, a motor for driving wheels 69a for rotation is provided. On the floor face F.L., a circular feeding path 71 is provided along the circular rail 70. The feeding path 71 is electrically connected to a storage battery 72. When the carriage 69 moves along the feeding path 71, electric power is fed to the motor provided in the carriage 69 from the storage battery 72 via the feeding path 71. Rotation of the motor in the carriage 69 is transmitted to the wheels 69a via gears.

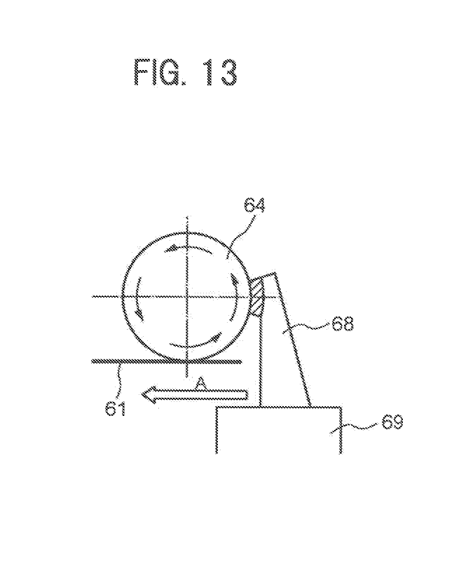

FIG. 13 illustrates a side view of the pushing member 68 on the carriage 69. When the carriage 69 moves along the circular rail 70, the pushing member 68 on the carriage 69 pushes the spherical body 64 in a direction of an arrow A in FIG. 13. When the pushing member 68 pushes the spherical body 64, the spherical body 64 performs the rolling motion on the drive rotating disc 61. When the spherical body 64 performs the rolling motion on the drive rotating disc 61, the drive rotating disc 61 rotates on the conical trajectory along the circular track 62a of the angle restricting plate 62 as illustrated in FIG. 12.

As illustrated in FIG. 12, on the drive rotating disc 61, a motion converting mechanism 75 for taking out rotation from the drive rotating disc 61 and converting it into rotary motion about a center line of an output shaft 74 is provided. The motion converting mechanism 75 includes a circular columnar main body portion 76 and the output shaft 74 connected to the main body portion 76. A bottom face of the circular columnar main body portion 76 is formed as a slope 76a conforming to the drive rotating disc 61. A plurality of spherical bodies 80 are embedded into the slope 76a to come in contact with the tilting drive rotating disc 61. The main body portion 76 is hollow. A support shaft 81 hangs from a position of a ceiling face of the main body portion 76 and displaced in a horizontal direction from the output shaft 74. At a tip end of the support shaft 81, a connecting portion 83 connected to the universal joint 65 with a universal joint 82 such as a spherical bearing interposed therebetween is provided. When the drive rotating disc 61 rotates on the conical trajectory about the universal joint 65, the output shaft 74 rotates about the center line.

A generator 85 is connected to the output shaft 74. The generator 85 converts the rotation energy of the output shaft 74 into electric energy. Electric power output by the generator 85 is stored in a storage battery 86.

The invention is not limited to the embodied forms in the above-described embodiments but can be changed into various embodiments without changing the gist of the invention. For example, in the power generation/transmission device in the first embodiment of the invention, as means of lifting and lowering the vertical moving rods, it is possible to use feed screw mechanisms using fuel, electric energy, air pressure, or the like as a drive source or pneumatic cylinders or hydraulic cylinders besides the buoyancy of the liquid.

It is only necessary for the drive rotating disc to be placed on the upper ends of the vertical moving rods to be slidable in the circumferential direction. For example, upper ends of vertical moving rods and a drive rotating disc may be connected with spherical bearings and circular arc guide devices interposed therebetween.

The present description is based on Japanese Patent Application No. 2012-131287 filed on Jun. 8, 2012 and Japanese Patent Application No. 2012-216643 filed on Sep. 28, 2012, all contents of which are incorporated herein.

### REFERENCE SIGNS LIST

1 water tank (storage tank)
2 special rotating disc
3 drive rotating disc
4 float
24 second universal joint
26 second angle restricting plate
26a circular track
31 second spherical body
32 first spherical body
33 rod connecting disc
34 spherical body placing disc
41 first universal joint
43 first angle restricting plate
43a circular track
51 motion converting mechanism
53 output shaft
F1 to F3 drive rod
W1 to W3 control rod
61, 101 drive rotating disc
62 angle restricting plate
64 spherical body
65 universal joint
63, 91 drive mechanism
68, 94 pushing member
74 output shaft
75 motion converting mechanism

1. A power generation/transmission device comprising:
a plurality of drive rods capable of rising and falling in a vertical direction;
a drive rotating disc supported to three-dimensionally rotatable about a first universal joint to rotate on a conical trajectory along a circular track of a first angle restricting plate disposed below the drive rotating disc; and
a first spherical body placed on the drive rotating disc to be capable of rolling motion, wherein
the drive rotating disc is placed on upper ends of the plurality of drive rods to be slidable in a circumferential direction, and
rising and falling motion of the plurality of drive rods and the rolling motion of the first spherical body are used to rotate the drive rotating disc.

2. The power generation/transmission device according to claim 1 further comprising:
a special rotating disc supported to be three-dimensionally rotatable about a second universal joint to rotate on a conical trajectory along a circular track of a second angle restricting plate disposed below the special rotating disc; and
a second spherical body placed on the special rotating disc to be capable of rolling motion, wherein
the plurality of drive rods are connected to the special rotating disc so as to synchronize rotary motion of the special rotating disc on the conical trajectory with rotary motion of the drive rotating disc on the conical trajectory.

3. The power generation/transmission device according to claim 1, wherein each of the plurality of drive rods has a float disposed in a storage tank for storing liquid and rises by using buoyancy acting on the float.

4. The power generation/transmission device according to claim 1 further comprising:
a motion converting mechanism for converting the rotary motion of the drive rotating disc on the conical trajectory into rotary motion of an output shaft.

5. The power generation/transmission device according to claim 3 further comprising:
a plurality of control rods capable of rising and falling in the vertical direction, wherein
rising and falling movements of the plurality of drive rods are controlled by rising and falling movements of the plurality of control rods.

6. The power generation/transmission device according to claim 2, wherein
the special rotating disc includes:
a rod connecting disc to which the plurality of drive rods are connected; and
a spherical body placing disc on which the second spherical body is placed, and
the spherical body placing disc is rotatable about the second universal joint relative to the rod connecting disc.

7. The power generation/transmission device according to claim 1, wherein
the drive rotating disc includes:
a spherical body rolling disc on which the first spherical body is placed to be capable of the rolling motion; and
a spherical body housing disc capable of rotating about the first universal joint relative to the spherical body rolling disc and having a housing portion for the first spherical body, and
the first spherical body rolls on the spherical body rolling disc to thereby rotate the spherical body housing disc relative to the spherical body rolling disc.

8. The power generation/transmission device according to claim 2, wherein a pinching portion for pinching the special rotating disc in the vertical direction is provided to a lower end of each of the plurality of drive rods.

9. The power generation/transmission device according to claim 2, wherein each of the plurality of drive rods has a float disposed in a storage tank for storing liquid and rises by using buoyancy acting on the float.

10. The power generation/transmission device according to claim 2 further comprising:
a motion converting mechanism for converting the rotary motion of the drive rotating disc on the conical trajectory into rotary motion of an output shaft.

11. The power generation/transmission device according to claim 2, wherein
the drive rotating disc includes:
a spherical body rolling disc on which the first spherical body is placed to be capable of the rolling motion; and
a spherical body housing disc capable of rotating about the first universal joint relative to the spherical body rolling disc and having a housing portion for the first spherical body, and
the first spherical body rolls on the spherical body rolling disc to thereby rotate the spherical body housing disc relative to the spherical body rolling disc.
